(19) United States
(12) Patent Application Publication
(10) Pub. No.: US 2015/0096188 A1
(43) Pub. Date: Apr. 9, 2015

(54) Clothes Dryer Static Charge Storage Device and Method of Reducing Static Charge In Clothes

(71) Applicant: Federal-Mogul Powertrain, Inc., Southfield, MI (US)

(72) Inventors: Annette Marchione, Tabernacle, NJ (US); Jaime Marrero, Chalfont, PA (US); Brian Lieb, Phoenixille, PA (US); Danielle Fong, San Francisco, CA (US); Jessica Fegeley, Bergenfield, NJ (US); Melissa Shaine, Marlton, NJ (US); Erika Saienni, Newark, DE (US)

(21) Appl. No.: 14/506,954

(22) Filed: Oct. 6, 2014

Related U.S. Application Data
(60) Provisional application No. 61/887,202, filed on Oct. 4, 2013.

(51) Int. Cl. C11D 17/04; C11D 3/00

(52) U.S. Cl. CPC C11D 17/047; C11D 3/001
USPC 34/380; 510/519

(57) ABSTRACT

A reusable clothes dryer static charge storage device and method of reducing static cling within clothes while tumbling in a dryer is provided. The device includes an outer housing having a conductive layer with a first conductivity and a capacitor received in the housing. The capacitor has conductive first and second walls spaced from one another. The device further includes a conductive member having a second conductivity that is greater than the first conductivity, with the conductive member being in direct electrical contact with one of the first and second walls of the capacitor, with the conductive member being spaced from the housing conductive layer by a gap. The first and second walls store the static charge accumulated from the clothing while tumbling in the dryer, whereupon the static charge is discharged to ground at a selected time.

### CROSS-REFERENCE TO RELATED APPLICATION

This application claims the benefit of U.S. Provisional Application Ser. No. 61/887,202, filed Oct. 4, 2013, which is incorporated herein by reference in its entirety.

### BACKGROUND OF THE INVENTION

1. Technical Field

This invention relates generally to static charge storing devices, and more particularly to portable, reusable clothes dryer static charge storing devices.

2. Related Art

Clothes dried in a tumbling dryer typically generate static. The static generally causes the clothes to cling together and to themselves, often referred to as “static cling.” Static cling can be extremely frustrating to the person separating and folding the clothes, as well as to the person wearing the clothes, as not only does it cause the clothing to appear unsightly, but it also acts as a source of attraction to hair, dust and the like, further causing the clothing to appear unsightly.

Efforts have been made to reduce static build-up within clothes tumbling in rotary clothes dryers, largely including disposable anti-static fabric sheets, however, these products are only suitable for single use, and then they must be replenished and replaced with new sheers. In addition, anti-static sheets do not conduct and store static charge, rather they deposit a wax residue on clothes to prevent static from being generated, which over time can reduce the luster of the clothes, and further, can cause some allergic reactions. Accordingly, use of anti-static sheets results in waste and expense, diminishing the luster of the clothes and potentially cause allergic reactions.

### SUMMARY OF THE INVENTION

In accordance with one aspect of the invention, a reusable clothes dryer static charge storage device is provided. The device includes an outer housing having a conductive layer with a first conductivity and a capacitor received in the housing. The capacitor conductive first and second walls are spaced from one another. The device further includes a conductive member having a second conductivity that is greater than the first conductivity, with the conductive member being in electrical contact with one of the first and second walls and being spaced from the conductive layer of the outer housing by a gap of a predetermined distance.

In accordance with a further aspect of the invention, the reusable clothes dryer static charge storing device can include a dielectric layer spacing the first and second walls from one another in their entirety.

In accordance with a further aspect of the invention, the reusable clothes dryer static charge storing device can further include a static discharge member being attached to one of the first and second walls and being in selective electrical communication with the other of the first and second walls.

In accordance with a further aspect of the invention, the reusable clothes dryer static charge storing device can further include a conductive annulus attached to the housing, with the static discharge member being operable to extend through the conductive annulus in electrical communication therewith.

In accordance with a further aspect of the invention, the conductive annulus can be configured in direct electrical communication with one of the first and second walls.

In accordance with a further aspect of the invention, the conductive layer of the housing can be formed as a textile layer interlaced at least in part with electrically conductive yarn.

In accordance with a further aspect of the invention, the housing can include a nonconductive polymeric inner layer to provide enhanced support to the conductive layer on an outer surface thereof.

In accordance with a further aspect of the invention, the nonconductive polymeric inner layer can have a through opening with the gap being radially aligned with the through opening to facilitate flow of electricity across the gap.

In accordance with a further aspect of the invention, the conductive layer can extend at least partially into the through opening of the nonconductive polymeric inner layer to further facilitate the flow of electricity across the gap.

In accordance with a further aspect of the invention, a method of reducing static charge build-up in clothes in a clothes dryer is provided. The method includes disposing a capacitor in the clothes dryer; transferring static charge from the clothes to the capacitor while drying the clothes in the clothes dryer; removing the capacitor from the clothes dryer; and connecting the capacitor to an electrical ground and discharging the static charge from the capacitor.

In accordance with a further aspect of the invention, the method can further include enclosing the capacitor in a protective, conductive housing.

In accordance with a further aspect of the invention, the method can further include discharging the static charge from the capacitor while the capacitor remains enclosed in a protective, conductive housing.

In accordance with a further aspect of the invention, the method can further include forming the protective housing at least in part from a conductive textile material.

In accordance with a further aspect of the invention, the method can further include forming the housing having an inner nonconductive, polymeric wall.

In accordance with a further aspect of the invention, the method can further include providing the electrical ground as an electrical outlet.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a perspective view of a clothes dryer static charge storage device constructed in accordance with one aspect of the invention;

FIG. 2 is a partial plan view of the clothes dryer static charge storage device of FIG. 1 showing an internal charge storage apparatus thereof;

FIG. 3A is a cross-sectional view of the internal charge storage apparatus of FIG. 2 shown in a charge storage state;

FIG. 3B is a view similar to FIG. 3A showing the internal charge storage apparatus in a discharge state;

FIG. 4 is a partial perspective view of the clothes dryer static charge storage device of FIG. 1 showing the internal charge storage apparatus;

FIG. 4A is an enlarged view of the encircled area 4A of FIG. 4 showing a conductive discharge member in a discharge state; and

FIG. 4B is a partial cross-sectional perspective view of the conductive discharge member of FIG. 4A.

### DETAILED DESCRIPTION OF PREFERRED EMBODIMENTS

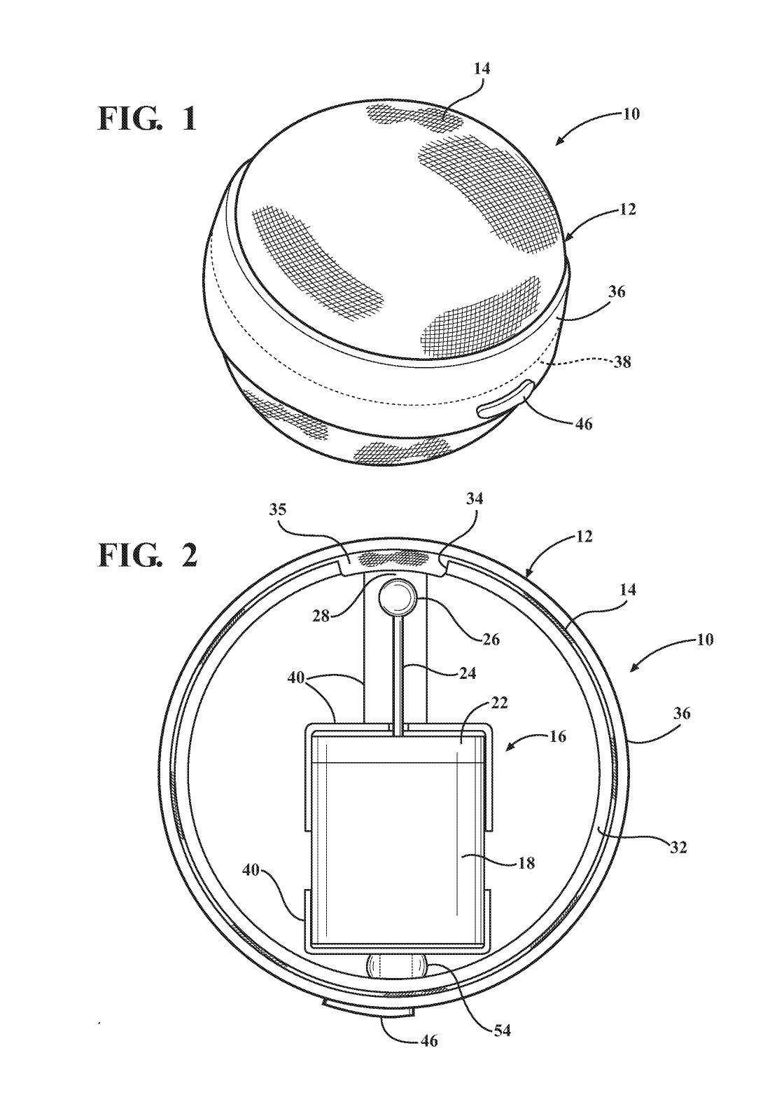

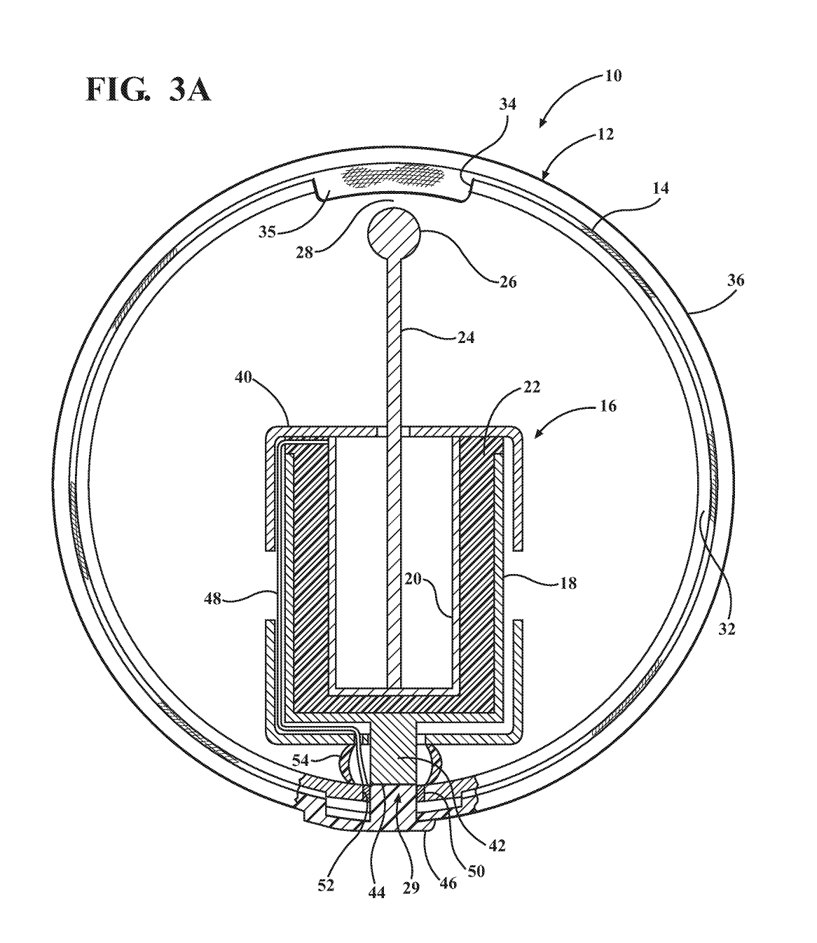

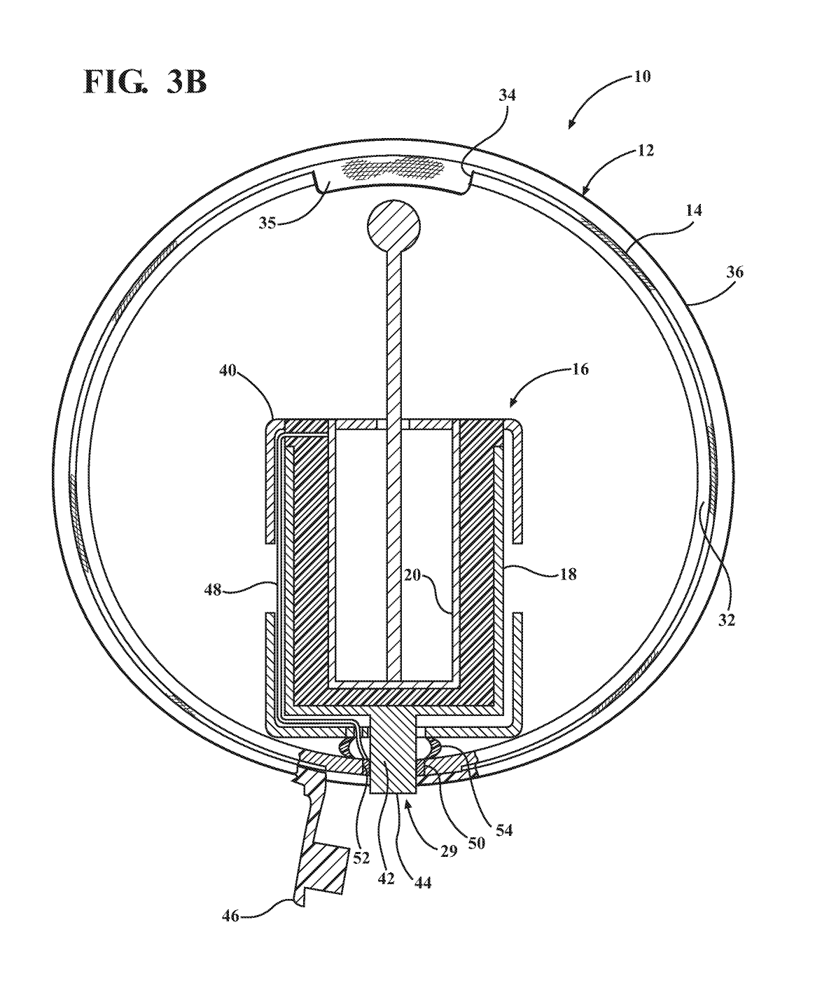

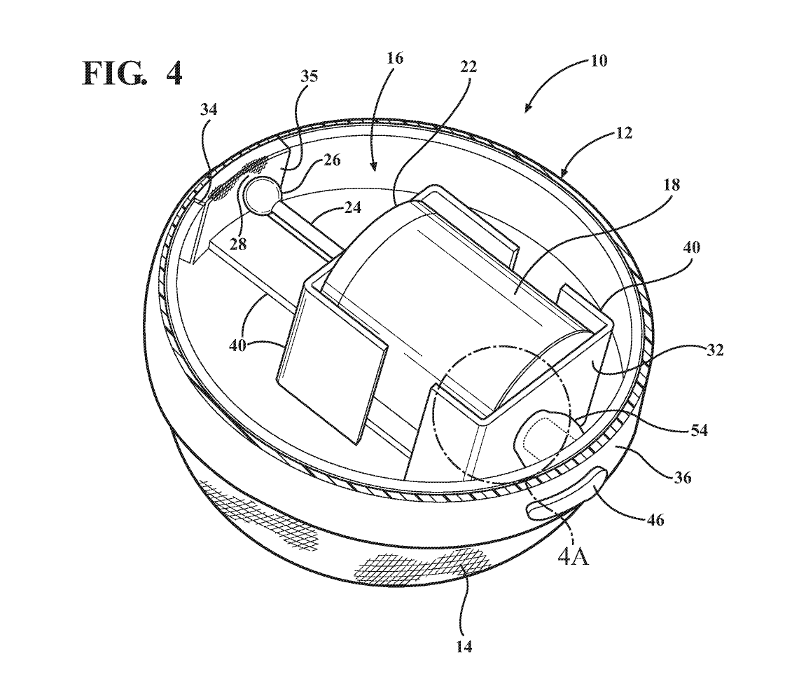

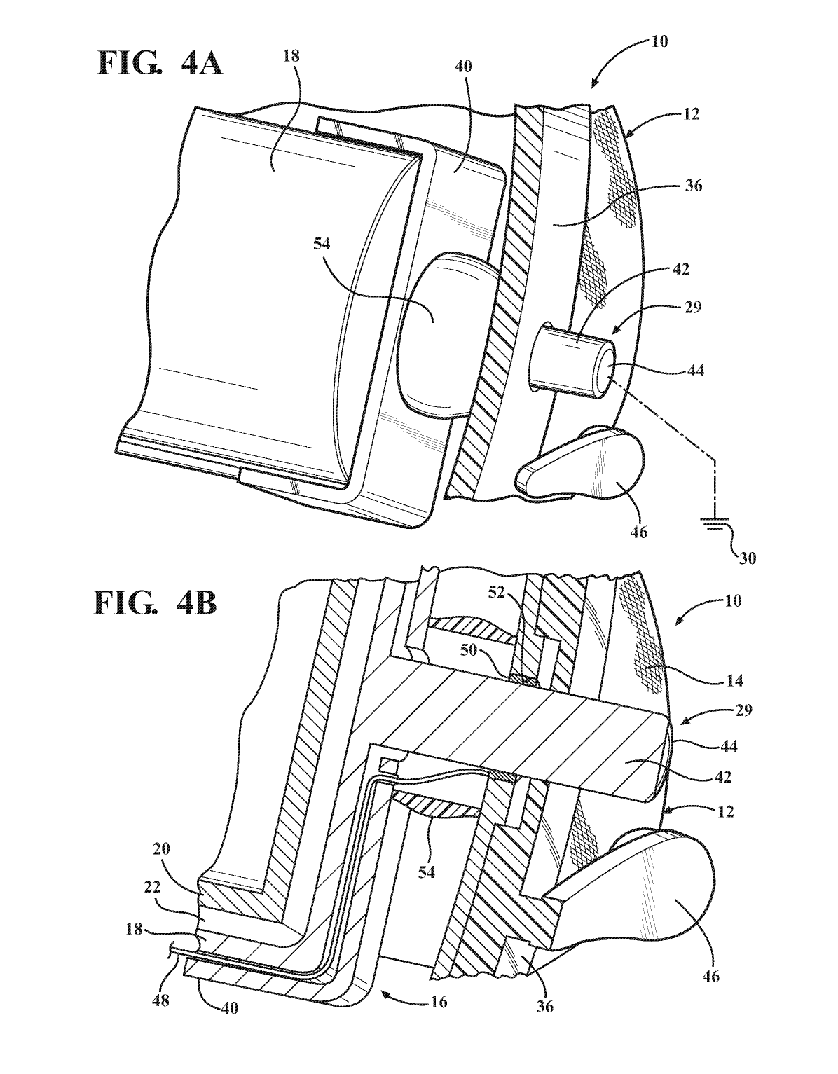

Referring in more detail to the drawings, FIG. 1 shows a reusable clothes dryer static charge storing device, referred to hereafter as device 10. As best shown in FIG. 2, the device includes an outer protective, conductive housing 12 having, at least in part, a conductive layer 14 with a first conductivity, with an internal charge storage apparatus, also referred to as capacitor 16, enclosed and contained in the housing 12. As best shown in FIGS. 3A and 3B, the capacitor 16 has a conductive inner, first wall 18 and a conductive outer, second wall 20, wherein the first and second walls 18, 20 are spaced in their entirety from one another by an intermediate dielectric wall 22. A conductive member, also referred to as conductive probe or probe 24, having a second conductivity that is greater than the first conductivity of the conductive layer 14, is fixed in direct electrical communication with one of the first and second walls 18, 20, shown as being attached to and extending upwardly from a floor or base of the generally cylindrical second wall 20. The probe 24 has a portion, shown as a spherical free end 26, by way of example and without limitation, spaced from the outer conductive housing 12 by a gap 28 of a predetermined distance. In use, the device 10 is placed in a clothes dryer and left therein for the duration of the drying cycle. As static electricity is generated by the tumbling clothing, the static charge initially formed within the clothes is conducted to the conductive layer 14, and from there, the static charge follows the path of least electrical resistance and crosses the gap 28 to the probe 24, given the probe 24 has a higher conductivity in comparison to the conductive layer 14. Then, from the conductive probe 24, the static charge accumulates in the second wall 20 that is attached directly to the probe 24, whereupon an equal but opposite charge is formed in the outer first wall 18. As such, the static charge generated by the tumbling clothing is transferred from the clothing and stored in the spaced apart first and second walls 18, 20 of the capacitor 16. Then, at a selected time, the stored charge within the capacitor 16 can be readily discharged from the first and second walls 18, 20 via a conductive discharge member 29 (FIGS. 3A-B, 4A-B) to a selected electrical ground 30 (FIG. 4A). Upon discharging the device 10, the device 10 is set to be reused over and over again. Accordingly, the static charge generated in the clothes during the drying cycle is effectively removed from the clothes and stored in the device 10 until the drying cycle is completed, whereupon the device 10 is selectively discharged to the electrical ground 30.

The conductive outer layer 14, which forms at least a portion of the housing 12, as shown in the Figures, can be formed having a generally spherical shape, however, it should be recognized that the outer layer 14 and housing 12 could be otherwise shaped, as desired, such as having a cylindrical shape, by way of example and without limitation. The conductive outer layer 14, as discussed above, is preferably formed as a conductive textile layer, such as via a woven, knit, or braided layer, wherein the conductive layer 14 includes at least some conductive yarn, such as a metalized yarn or wire, by way of example and without limitation. Of course, it is contemplated that the outer conductive layer 14 could be formed as a metal or metalized layer of material, if desired, however, if the outer layer 14 is constructed as a textile material, the textile material provides the housing 12 with added cushion and softness, which in turn facilitates the ability of the device 10 to function and tumble with minimal noise generation within the tumbling drum of the dryer. To facilitate maintaining the housing 12 in its desired geometry, the housing 12 can include a nonconductive inner layer 32 formed of a more rigid material than the textile conductive layer 14, such as a high temperature, high impact resistant polymeric material, such as high impact polystyrene (HIPS), by way of example and without limitation. If an inner layer 32 is included, the inner layer 32 preferably has a through opening 34 to allow the static electricity to flow freely from the outer layer 14 to the probe 24. To facilitate the static electricity flowing through the through opening 34 and bridging the gap 28 between the housing 12 and the probe free end 26, a portion 35 of the conductive layer 14 preferably extends into the through opening 34 to facilitate forming the desired width of the gap 28. Accordingly, the through opening 34 is radially aligned with the gap 28 and the free end 26 of the probe 24. To further provide the housing 12 with a cushiony softness, an elastic band of material 36, such as high temperature polymeric material, e.g. ethylene propylene, can be provided over a portion of the outer surface, shown as extending about and covering a seam 38 formed between mating parts, shown as mating hemispherically shaped halves of the housing 12.

The capacitor 16 is received inside the conductive outer layer 14. To facilitate retaining the capacitor 16 therein, the housing 12, and in particular, the inner layer 32 of the housing 12 is shown as having a mount feature 40 therein, wherein the mount feature 40 can be formed as a monolithic piece of material with the inner layer 32, or otherwise, can be formed as a separate piece of material from the inner layer 32 and fixed thereto. The mount feature 40 has a portion sized to slidably receive the capacitor 16 therein, such as in a line-to-line or slightly tight fit, or to snappingly receive the capacitor therein, such that the capacitor 16 is held firmly against movement relative to the housing 12.

The static discharge member 29 can be formed as an integral component of the device 10. The static discharge member 29 has a conductive member 42 that is selectively engageable and disengageable from simultaneous electrical communication with both the first and second walls 18, 20 and has an end portion 44 selectively engageable with the electrical ground 30, such as that of an electrical outlet or otherwise, by way of example and without limitation, to discharge the stored static charge from the first and second walls 18, 20 of the capacitor 16. The static discharge member 29 can be fully enclosed within the housing 12 when in a non-discharged state, and can be protected and concealed by a protective cap or cover 46, which both acts to protect the discharge member 29 from unwanted exposure and from inadvertent discharge. The cover 46 is represented as be a flexible member fixed to the band 36, and can be formed as a separate piece or a monolithic flap of material with the band 36. Accordingly, when the discharge member 29 is not in use, the cover 46 overlies and conceals the discharge member 29 so that it is fully concealed, wherein the discharge member 29 remains out of electrical contact with, and out of electrical communication with both walls 18, 20, and thus, the first and second walls 18, 20 remain isolated and out of electrical contact from one another. However, when the discharge member 29 is in use, the discharge member 29 is brought into electrical communication with both the first and second walls 18, 20 and also with the electrical ground 30. The discharge member 29 can be brought into electrical communication with the first and second walls 18, 20 by depressing at least a portion of the flexible housing 16, which not only causes the discharge member 29 to be bought into electrical communication with both the first and second walls 18, 20, but also causes it to extend radially outwardly from the housing 12 so the that the end portion 44 is freely exposed for electrical communication with the source of ground 30 (FIGS. 4A and 4B). Upon discharging the device 10, the compressive force can be released from the housing 12, thereby allowing the housing 12 to resiliently and automatically return to its unbiased, non-flexed shape, whereupon the discharge member 29 automatically returns to its concealed, enclosed position within the housing 12, and out of electrical communication with both the first and second walls 18, 20 (FIG. 2).

As best in FIGS. 3A-B, and 4B, the conductive member 42 of the discharge member 29 can be fixed directly to the first wall 18 of the capacitor 16 such that it is in permanent electrical communication therewith. To facilitate bringing the conductive member 42 into electrical communication with the second wall 20, a conductive member, such as a conductive, insulated wire 48, can be fixed in electrical communication with the second wall 20, such that the wire 48 can be brought into selective electrical communication with the conductive member 42 during a discharge event. As such, the first and second walls 18, 20 are selectively brought into electrical communication with one another during a discharge event. To facilitate bringing the wire 48 into electrical communication with the conductive member 42, a further conductive member, represented as a conductive annulus or metallic ring 50, by way of example and without limitation, can be attached within a through opening of the housing 12 and connected to the wire 48, thereby bringing the metallic ring 50 into electrical communication with one of the first and second walls 18, 20, and shown as the second wall 20 given this is the wall to which the electrical wire 48 is attached. As such, during a discharge event, the conductive member 42, arranged in axial alignment with the opening in the metallic ring 50, is extended through the metallic ring 50 and thus, is brought into electrical contact with the metallic ring 50. Accordingly, the first and second walls 18, 20 are brought into electrical communication with one another, via the wire 48 and ring 50, upon depressing the housing 12 and extending the conductive member 42 through the metallic ring 50 in electrical communication therewith. As discussed above, ideally the conductive member 42 is registered with a ground 30 of an electrical outlet during discharge, wherein the stored static electricity is discharged to ground 30. Upon completing the discharge event, the housing 12 is allowed to relax, whereupon the conductive member 42 is automatically retracted back into the housing 12 and out of electrical communication with the metallic ring 50. To facilitate the housing 12 returning to its relaxed configuration, an elastic member 54, such as an elastic, spherically-shaped, grommet or the like, can be disposed about the conductive member 42 between the mount feature 40 and the housing 12. Of course, it should be recognized that the conductive member 42 is sized for a clearance fit within a through passage of the elastic member 54 to avoid inferring with the relative movement thereof when the housing 12 is depressed. As such, upon the housing 12 returning to its relaxed configuration, the first and second walls 18, 20 are no longer in electrical communication with one another, such that the device 10 is ready for further use, as desired.

Obviously, many modifications and variations of the present invention are possible in light of the above teachings. It is, therefore, to be understood that within the scope of the appended claims, the invention may be practiced otherwise than as specifically described.

What is claimed is:

1. A reusable clothes dryer static charge storing device, comprising:
a housing having a conductive layer with a first conductivity;
a capacitor received in said housing, said capacitor having conductive first and second walls spaced from one another; and
a conductive member having a second conductivity that is greater than said first conductivity, said conductive member being in electrical contact with one of said first and second walls and being spaced from said conductive layer of said outer housing by a gap of a predetermined distance.

2. The reusable clothes dryer static charge storing device of claim 1 further including a dielectric layer spacing said first and second walls from one another in their entirety.

3. The reusable clothes dryer static charge storing device of claim 1 further including a static discharge member, said static discharge member being attached to one of said first and second walls and being in selective electrical communication with the other of said first and second walls.

4. The reusable clothes dryer static charge storing device of claim 3 further including a conductive annulus attached to said housing, said static discharge member being operable to extend through said conductive annulus in electrical communication therewith.

5. The reusable clothes dryer static charge storing device of claim 4 wherein said conductive annulus is in electrical communication with one of said first and second walls.

6. The reusable clothes dryer static charge storing device of claim 1 wherein said conductive layer of said housing is a textile layer interlaced at least in part with electrically conductive yarn.

7. The reusable dryer static charge storing device of claim 1 wherein said housing includes a nonconductive polymeric inner layer supporting said conductive layer on an outer surface thereof.

8. The reusable dryer static charge storing device of claim 7 wherein said inner layer has a through opening with said gap being radially aligned with said through opening.

9. The reusable dryer static charge storing device of claim 8 wherein said conductive layer extends into said through opening.

10. A method of reducing static charge storage in clothes in a clothes dryer, comprising:
disposing a capacitor in the clothes dryer;
transferring static charge from the clothes to the capacitor while drying the clothes in the clothes dryer;
removing the capacitor from the clothes dryer; and
connecting the capacitor to an electrical ground and discharging the static charge from the capacitor.

11. The method of claim 10 further including enclosing the capacitor in a protective, conductive housing.

12. The method of claim 11 further including discharging the static charge from the capacitor while the capacitor remains enclosed in the housing.

13. The method of claim 11 further including providing the housing having an outer conductive textile layer.

14. The method of claim 13 further including providing the housing having an inner nonconductive, polymeric wall.

15. The method of claim 11 further including providing the electrical ground as an electrical outlet.
